(19) United States
(12) Patent Application Publication
(10) Pub. No.: US 2011/0251702 A1
(43) Pub. Date: Oct. 13, 2011

(54) METHOD FOR RECORDING A DMX SIGNAL

(75) Inventor: Banly Cheung, Hong Kong (CN)

(73) Assignee: KONINKLIJKE PHILIPS ELECTRONICS N.V., EINDHOVEN (NL)

(21) Appl. No.: 13/120,667

(22) PCT Filed: Sep. 22, 2009
(86) PCT No.: PCT/CN2009/074122

§ 371 Date: Jun. 30, 2011

(30) Foreign Application Priority Data
Sep. 27, 2008 (CN) 200810169835.4

(51) Int. Cl. G06F 17/00

(52) U.S. Cl. 700/90

(57) ABSTRACT

A method for recording a DMX signal is disclosed. Firstly, the DMX signal within a time period is edited in a signal source device, an initiating identification signal is edited and set before the data of the first frame of the DMX signal, and an ending identification signal is edited and set after the data of the last frame. Secondly, a recording procedure in a recording device is set to identify the data of each received frame, to initiate a record when the initiating identification signal appears, and to end the record when the ending identification signal appears.

### FIELD OF THE INVENTION

The present invention relates to a method for recording a signal, in particular relates to a method for recording a lighting control signal based on DMX protocol.

### BACKGROUND OF THE INVENTION

Digital control is applied for most of professional lighting devices, such as a digital lighting console, a digital dimmer pack, a light with computerized effects, a computerized color-changing light, a computerized color scroller for a follow spot light, a laser light, etc., used in large outdoor performance activities of modern society, such as a square party, a large or medium solo concert, and a large or medium indoor stage play. However, it is problematic for lighting designers how these devices can be inter-connected to achieve an accurate control of the arrangement of these devices to realize an integrated schedule of stage light.

Modern stage light designer raises a new management concept, namely centralized management, centralized control. It means that a plurality of digital lighting devices with various functional effects are connected together and controlled by a digital lighting console. For example, practice has proved that a digital dimmer pack, a digital color scroller, a light with computerized effects, a computerized color scroller, a digital fogger, a digital bubble machine and the like are connected to a computerized console controlled by a lighting artist. Here, a DMX signal system well-known by those skilled in the lighting control field is involved.

DMX is the abbreviation for Digital Multiplex, defined by United States Institute for Theater Technology (USITT). As a widely adopted digital lighting data protocol, it has been admitted and conformed by the manufacturers of stage devices all around the world. In other words, in order to achieve the centralized control, each controlled unit in this link should be conformed to the specification of this protocol.

The unit in DMX protocol is a “frame”, data in each frame may drive 512 lighting loops at most, and a valid light adjustment value should be in the range of 0-255 (decimal) or 00-FF (hexadecimal). This property of DMX allows a linear light adjustment for lighting loops by adjusting DMX light adjustment values. DMX controller is a device continuously sending DMX signals.

However, due to the large size of the traditional DMX controller as well as the high price of the entire device, a small-sized DMX controller with only simple functions such as sending DMX signals has been designed by simplification. This DMX controller can record DMX signals of a traditional full functional DMX controller, and send out these DMX signals during operation so as to achieve a control of digital lighting devices. This invention relates to the technical field of implementing the recording of the DMX signals between such simplified DMX controller and the traditional full functional DMX controller.

Nowadays, a popular method for recoding a DMX signal in the field is as following: after the circuit connection of a recording device (i.e. a simplified DMX controller) and a signal source device (e.g., a full functional DMX controller), manual operations, namely simultaneously pressing a “Send Button” of the signal source device and a “Record Button” of the recording device, are applied so that the DMX signal sent by the signal source device is recorded by the recording device; and when the recording ends, manual operations, namely simultaneously pressing a “Stop Sending Button” of the signal source device and an “End Recording Button” of the recording device, are applied to terminate the record. Obviously, it is difficult for such manual operations to be synchronized: recording less data frames (part of the DMX control signal is lost since, for example, the “Record Button” is pressed later than the “Send Button” when the record is initiated) or recording more data frames (extra DMX control signal is additionally recorded since, for example, the “End Recording Button” is pressed later than the “Stop Sending Button” when the record ends) often occurs to the recorded DMX control signal within a time period. The DMX signal within a time period recorded by using this method, namely the control procedure of digital lighting devices within the time period, either lacks of data frames or has extra data frames. This is obviously disadvantageous to the effective control of stage lighting.

### SUMMARY OF THE INVENTION

The invention aims to provide a method for accurately recording a DMX signal within a desired time period so as to solve the problem in the prior art in that manual operations are required for recording a DMX signal and it often occurs that less data or more data is recorded.

The method for recording the DMX signal is implemented as:

A method for recording a DMX signal, characterized by comprising the following steps:
(1) in a signal source device, editing the DMX signal within a time period, editing and setting an initiating identification signal before the data of the first frame of the aforementioned DMX signal, and editing and setting an ending identification signal after the data of the last frame of the aforementioned DMX signal;
(2) setting a recording procedure in a recording device to identify the data of each frame received, to initiate a record when the initiating identification signal appears, and to end the record when the ending identification signal appears;
(3) initiating the recording device to enter the recoding procedure;
(4) initiating the signal source device to send signal.

In a preferable embodiment, the identification signal is a frame of data being all zeros.

The implementation of the method of recording the DMX signal of the invention enables the recording device to judge, by itself, the initiating position and the ending position of the DMX signal required to be recorded without having to rely on any manual operation, and thus guarantees the accuracy of the recorded data, so that the functionally simplified DMX controller can be used in an easy way, and a low-cost centralized control of stage lighting is achieved.

### BRIEF DESCRIPTION OF THE DRAWINGS

FIG. 1 shows a schematic view of data structure of a DMX signal;

FIG. 2 shows a schematic view of a method for recording according to the prior art;

FIG. 3a shows a flow chart of a method for recording according to this invention;

FIG. 4 shows a schematic view of data structure of a signal edited in a signal source device according to this invention;

### DETAILED DESCRIPTION OF EMBODIMENTS

A method for recording a DMX signal according to this invention is further described below in combination with the accompanying drawings and the embodiments.

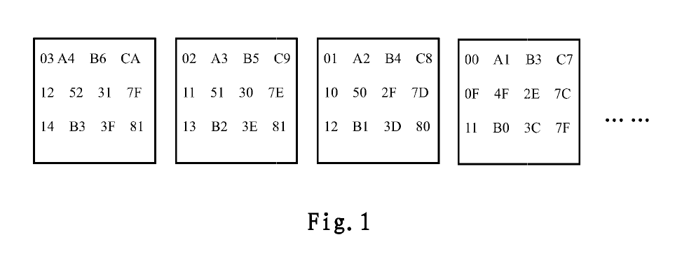

As illustrated in FIG. 1, the core of a centralized control system for stage lighting based on DMX protocol is a lighting control procedure within a time period, namely a period of DMX signal; the DMX signal is composed of a plurality of frames of data, and each frame of data can drive at most 512 lighting loops to control various of stage lighting devices in the link respectively. In each frame of data, a valid light adjustment value should be in the range of 0-255 (decimal) or 00-FF (hexadecimal).

This property of DMX allows a linear light adjustment of the lighting loop by adjusting the DMX light adjustment value. A DMX controller is a device continuously sending the aforementioned DMX signal to the connected stage lighting devices.

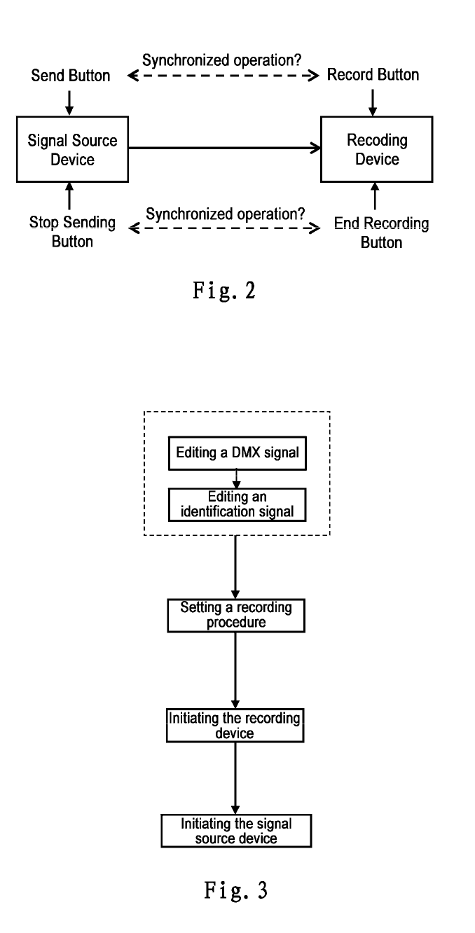

As shown in FIG. 2, in a method for recording a DMX signal according to the prior art, after the circuit connection of a recording device (i.e. a simplified DMX controller) and a signal source device (e.g., a full functional DMX controller), manual operations, namely simultaneously pressing a “Send Button” of the signal source device and a “Record Button” of the recording device, are applied so that the DMX signal sent by the signal source device is thus recorded by the recording device; and when the recording ends, manual operations, namely simultaneously pressing a “Stop Sending Button” of the signal source device and an “End Recording Button” of the recording device, are applied to terminate the recording. Obviously, it is difficult for such manual operations to be synchronized: recording less data frames (part of the DMX control signal is lost since, for example, the “Record Button” is pressed later than the “Send Button” when the record is initiated) or recording more data frames (extra DMX control signal is additionally recorded since, for example, the “End Recording Button” is pressed later than the “Stop Sending Button” when the record ends) often occurs to the recorded DMX control signal within a time period. The DMX signal within a time period recorded by using this method, namely the control procedure of digital lighting devices within the time period, either lacks of data frames or has extra data frames. This is obviously disadvantageous to the effective control of stage lighting.

As shown in FIG. 3, the method for recording DMX signal according to this invention is as following:

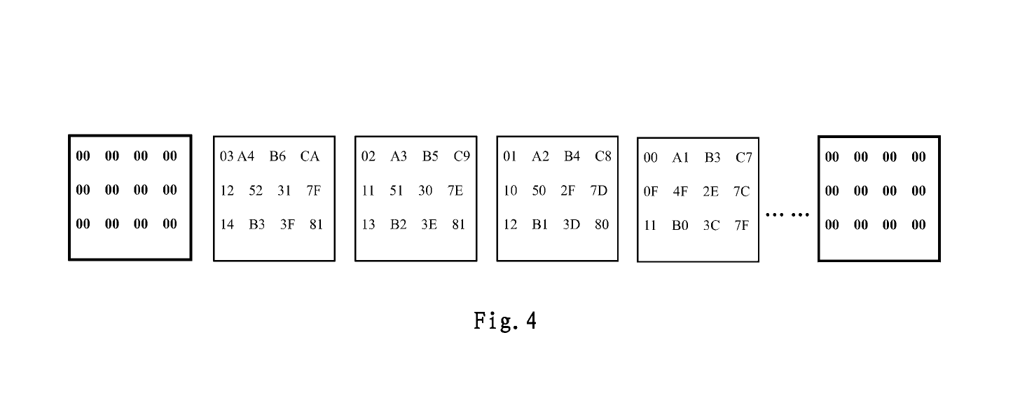

Firstly, a period of DMX signal is edited in a signal source device such as a full functional DMX controller; this period of DMX signal is actually the control procedure of digital lighting devices within a time period, and is composed of a plurality of frames of data (please refer to FIG. 1); various light adjustment values for the connected lighting loops are contained in each frame of data, and the stage lighting designer achieves a linear light adjustment of the connected lighting loops by using these light adjustment values. After the aforementioned editing is accomplished, the full functional DMX controller can be connected into a lighting control system and continuously send DMX signals to various digital lighting devices in the system so as to achieve the effect of the lighting design of the stage lighting designer. As introduced in the background part, due to the large size of the full functional DMX controller as well as the high price of the entire device, a small-sized DMX controller with only simple functions such as sending a DMX signal has been designed by simplification. This simplified functional DMX controller only needs to record the DMX signal in the aforementioned full functional DMX controller, and to send the DMX signal to the connected lighting loops during operation so that the control of the digital lighting devices is achieved at a low cost. In order to achieve the same technical effect as mentioned above at a low cost, according to the method for recording in this invention, after the aforementioned editing is accomplished, an initiating identification signal is further edited and set before the data of the first frame of the aforementioned edited DMX signal, and an ending identification signal is edited and set after the data of the last frame of the aforementioned edited DMX signal. After such editing is accomplished, the data structure of the edited DMX signal is, as shown in FIG. 4, a structure with both the starting and the ending parts being identification signals and the middle part being a DMX signal.

Secondly, according to the method of recording in this invention, a recording procedure in a recording device, namely a simplified functional DMX controller, is set to identify the data of each received frame. Moreover, the recording device is further set as following: when the “initiating identification signal” appears, namely that the recording device receives and identifies the “initiating identification signal”, a record is initiated under the control of the recording procedure to record the signal after the “initiating identification signal” into the recording device; and when the “ending identification signal” appears, namely the recording device receives and identifies the “ending identification signal”, the record is ended under the control of the recording procedure.

After the editing and setting are accomplished, the recording device is then initiated to enter the recording procedure, and the signal source device is initiated to send the signal.

In this manner, the recording of the recording device is automatic, and no longer requires manual operations. Such method of judging the initiating position and the ending position of the DMX signal needed to be recorded by the record device itself guarantees the accuracy of the recorded data, so that the functional simplified DMX controller can be easily used, and a low-cost centralized control of stage lighting is achieved.

In a preferable embodiment of this invention, as shown in FIG. 4, each of the initiating identification signal and the ending identification signal is a frame of data being all zeros. In other words, a frame of data being all zeros is edited and set as the initiating identification signal before the data of the first frame of the DMX signal; a frame of data being all zeros is edited and set as the ending identification signal after the data of the last frame of the DMX signal; and the data frames used as the stage lighting control procedure within a time period is located between the identification data frames with all being zeros. In this manner, when the recording device receives a data frame with all being zeros, the recording device initiates a record under the control of the recording procedure to record the signal after this data frame into the recording device; and when the recording device receives again a data frame with all being zeros, the recording device ends the record under the control of the recording procedure. In a DMX signal, the light adjustment value with all being zeros means that all light are out, or is equivalent to that the DMX controller does not send any light adjustment control signal to the stage lighting devices. Thus, in this preferable embodiment, setting a data frame with all being zeros as the identification signal will further simplify the work of the stage lighting designer, and in the meanwhile, it makes the lighting control procedure designed by a certain lighting designer can be easily read by others.

Generally, the embodiments described in the above do not represent all the implementation ways of this invention; the embodiments in the above are not intended to specifically limit the invention, and all the configurations similar to the solution of this invention should fall into the protection scope of this invention.

1. A method for recording a DMX signal, comprising the following steps:
in a signal source device, editing the DMX signal within a time period, editing and setting an initiating identification signal before data of the first frame of the aforementioned DMX signal, and editing and setting an ending identification signal after data of the last frame of the aforementioned DMX signal;
setting a recording procedure in a recording device to identify data of each received frame, to initiate a record when the initiating identification signal appears, and to end the record when the ending identification signal appears;
initiating the recording device to enter the recoding procedure;
initiating the signal source device to send a signal.

2. A method for recording a DMX signal according to claim 1, wherein the identification signal is a frame of data being all zeros.
